(19) United States
(12) Patent Application Publication
(10) Pub. No.: US 2021/0125130 A1
(43) Pub. Date: Apr. 29, 2021

(54) PLAN GENERATING DEVICE AND PLAN GENERATION METHOD

(71) Applicant: HITACHI, LTD., Tokyo (JP)

(72) Inventors: Yuichi KOBAYASHI, Tokyo (JP); Yasuharu NAMBA, Tokyo (JP)

(21) Appl. No.: 17/071,044

(22) Filed: Oct. 15, 2020

(30) Foreign Application Priority Data
Oct. 29, 2019 (JP) 2019-196325

(51) Int. Cl. G06Q 10/06; G06K 9/62

(52) U.S. Cl. CPC G06Q 10/06316; G06Q 50/04; G06K 9/6263; G06Q 10/0633

(57) ABSTRACT

A plan generator uses plan requirement data read from a storage device and modification know-how data read from the storage device to determine a decision variable for a new plan so that the new plan satisfies a constraint and an objective function and is aligned with any of groups included in the modification know-how data. The modification know-how data includes a plurality of groups for which an anti-pattern indicating trends of job patterns of a plurality of plans before modification, a reference pattern indicating trends of job patterns of a plurality of plans after modification that have been obtained by modifying the plans before the modification by a planner, and a modification rate that is a statistical amount of the plan-related information and the decision variables of the plurality of plans before the modification, have been obtained.

### CROSS-REFERENCE TO RELATED APPLICATION

This application claims priority to Japanese Patent Application No. 2019-196325 filed on Oct. 29, 2019, the entire contents of which are incorporated by reference herein.

### BACKGROUND OF THE INVENTION

The present invention relates to a plan generating device and a plan generation method, and more particularly to a plan generating device and a plan generation method that can generate a plan in which modification know-how extracted via modification by a planner has been reflected.

The number of events for which advance plans are important and that are the manufacture of products, the operation and management of a large system, and the like is large. In the generation of such a plan, it is necessary to generate the plan satisfying the plan's objective functions of maximizing production, maximizing facility utilization, and minimizing the number of workers, while complying with constraints for resources such as time, a space, a facility, and a person. Since manually generating the plan is time-consuming too much, a computer is used in many cases.

In an actual environment, a plurality of constraints and a plurality of objective functions are complex. Therefore, there is a case where it is difficult to accurately define all the constraints and all the objective functions and input all the constraints and all the objective functions to the computer. In this case, it is possible to improve the accuracy of the plan by defining the constraints and the objective functions in possible ranges and combining the constraints and the objective functions with empirical logic. However, it is very difficult to define, in the computer, the constraints and the objective functions that completely simulate the actual environment, and the empirical logic lacks versatility and extensibility. Therefore, a plan output by the computer hardly satisfies a planner.

To avoid this, there is a proposed technique for measuring ambiguous priorities of the plurality of constraints and the plurality of objective functions based on a result of modifying, by the planner, the plan output by the computer, and for reflecting the priorities in the generation of a next plan.

For example, a priority determining device that is disclosed in Japanese Unexamined Patent Application Publication No. Hei 06-333064 and configured to determine priorities of a plurality of devices determines the priorities using a weight coefficient for a requirement. When the determined priorities are not satisfied, a planner modifies the priorities so that the planner is satisfied with the priorities. Then, the planner treats, as a teacher signal, a weight coefficient given by evaluating a requirement based on the modified priorities, and causes the priority determining device to learn relationships between the teacher signal and input data.

In addition, Japanese Unexamined Patent Application Publication No. 2013-14387 discloses an evaluation parameter learning device that receives an automatic vehicle allocation plan generated by an automatic vehicle allocation plan generating device, a manual vehicle allocation plan modified by a planner, an evaluation value of the automatic vehicle allocation plan, and a target evaluation value, treats evaluation item values of the received manual vehicle allocation plan and the received automatic vehicle allocation plan as input data of teacher data, and learns the evaluation value and the target evaluation value as output values of the teacher data.

In Japanese Unexamined Patent Application Publication No. Hei 06-333064 and Japanese Unexamined Patent Application Publication No. 2013-14387, ambiguous priorities of a plurality of constraints and a plurality of objective functions can be reproduced based on preference of a planner. However, as described above, the actual environment is not completely reflected in the constraints defined in the computer and the objective functions defined in the computer. It is not possible to support the case where a constraint not defined in the computer exists or the case where a constraint and an objective function that are complex and are hardly defined latently exist.

The present invention enables plan generation with high accuracy by reflecting modification know-how extracted from a plan before modification and a plan after the modification by a planner.

### SUMMARY OF THE INVENTION

A plan generating device according to an aspect of the present invention includes a storage device, an input device, and a plan generator. The storage device stores plan requirement data indicating a constraint and an objective function that are used to generate a plan, and modification know-how data indicating modification know-how for the plan. The input device receives new plan-related information data indicating predetermined plan-related information including an explanatory variable of the constraint and the objective function for the new plan. The plan generator uses the new plan-related information data received from the input device, the plan requirement data read from the storage device, and the modification know-how data read from the storage device to determine a decision variable for the constraint and the objective function. The modification know-how data includes a plurality of groups for which an anti-pattern indicating trends of job patterns of a plurality of plans before modification, a reference pattern indicating trends of job patterns of a plurality of plans after modification that have been obtained by modifying the plans before the modification by a planner, and a modification rate that is a statistical amount of the plan-related information and the decision variable of the plurality of plans before the modification, have been obtained. The plan generator determines the decision variable for the new plan so that the new plan satisfies the constraint and the objective function and is aligned with any of the groups included in the modification know-how data.

A plan generation method according to another aspect of the present invention uses a plan generating device including a storage device, an input device, and a plan generator. The storage device stores plan requirement data indicating a constraint and an objective function that are used to generate a plan and modification know-how data indicating know-how for the plan. The input device receives plan-related information data indicating predetermined plan-related information including an explanatory variable of the constraint and the objective function for the plan. The plan generator determines a decision variable for the constraint and the objective function. The modification know-how data includes a plurality of groups for which an anti-pattern indicating trends of job patterns of a plurality of plans before modification, a reference pattern indicating trends of job patterns of a plurality of plans after modification that have been obtained by modifying the plans before the modification by a planner, and a modification rate that is a statistical amount of the plan-related information and the decision variable of the plurality of plans before the modification, have been obtained. The plan generation method includes the steps of causing the input device to receive new plan-related information data indicating the plan-related information of the new plan, and causing the plan generator to use the new plan-related information data received from the input device, the plan requirement data read from the storage device, and the modification know-how data read from the storage device to determine the decision variable for the new plan so that the new plan satisfies the constraint and the objective function and is aligned with any of the groups included in the modification know-how data.

It is possible to generate a plan with high accuracy by reflecting modification know-how extracted from a plan before modification and a plan after the modification by a planner.

Other challenges and new features will be clarified from the description of the present specification and the accompanying drawings.

### BRIEF DESCRIPTION OF THE DRAWINGS

FIG. 1 illustrates an example of a configuration of a plan generating device;

FIG. 2 is a diagram illustrating an example of a plan;

FIG. 3 illustrates an example of a data structure of plan information;

FIG. 4 illustrates an example of a data structure of product information;

FIG. 5 illustrates an example of a data structure of a plan result before modification;

FIG. 6 illustrates an example of a data structure of a plan result after the modification;

FIG. 7 illustrates an example of a data structure of a modification log;

FIG. 8 illustrates an example of a data structure of a modification rate table What;

FIG. 9 illustrates an example of a data structure of a modification rate table When;

FIG. 10 illustrates an example of a data structure of a modification rate table Where;

FIG. 11 illustrates an example of a data structure of a modification rate table Which;

FIG. 12 is a diagram illustrating an example of definitions of job patterns;

FIG. 13 illustrates an example of a data structure of an anti-pattern;

FIG. 14 illustrates an example of a data structure of a reference pattern;

FIG. 15 illustrates an example of a data structure of modification know-how;

FIG. 16 is a flow diagram illustrating a process to be executed by a modification know-how learning section;

FIG. 17 is a flow diagram illustrating a process to be executed by a plan generator;

FIG. 18 is a flow diagram illustrating a process of generating a plan using modification know-how; and

FIG. 19 is a flow diagram illustrating a process of evaluating a plan.

### DETAILED DESCRIPTION OF THE PREFERRED EMBODIMENTS

### Embodiment

Hereinafter, an embodiment of the present invention is described with reference to the drawings. A plan generating device according to the embodiment learns modification know-how from a plan before modification and a plan after the modification and uses the learned modification know-how to generate a plan with high accuracy. The plan to be generated by the plan generating device is not limited. The embodiment may be applied to various plans such as plans for production in a facility, maintenance of social infrastructure, and personnel allocation. The embodiment describes, as an example, the plan generating device that generates a production plan to work in a process determined in advance and manufacture a product.

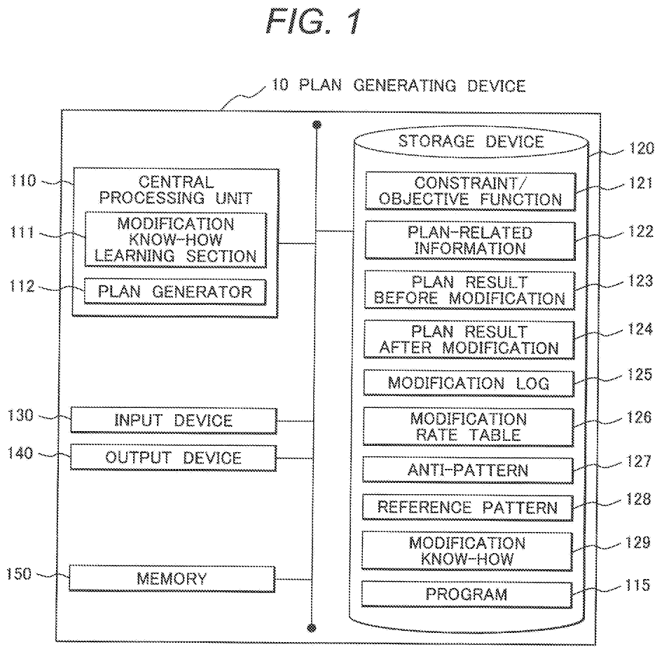

FIG. 1 illustrates an example of a configuration of the plan generating device 10. The plan generating device 10 accumulates modification details manually modified by a planner for the production plan generated by a predetermined algorithm to obtain modification know-how. The plan generating device 10 reflects the obtained modification know-how in the production plan generated by the predetermined algorithm and generates a new plan. In addition, the plan generating device 10 continuously updates the modification know-how by learning the modification know-how each time the plan generating device 10 generates a plan. As a specific configuration that achieves the plan generating device 10, a main frame, a personal computer, or the like is assumed and described. The specific configuration, however, may be achieved by using cloud computing.

The plan generating device 10 has the following hardware configuration. Specifically, the plan generating device 10 includes a storage device 120, a memory 150, a central processing unit (CPU) 110, an input device 130, and an output device 140. The storage device 120 is composed of a nonvolatile storage device such as a solid state drive (SSD), magnetic medium such as a hard disk drive, or the like. The memory 150 is a composed of a volatile storage device such as a random-access memory (RAM). The central processing unit 110 reads a program 115 held in the storage device 120 into the memory 150 and executes the program 115 to comprehensively control the plan generating device 10. The central processing unit 110 executes various types of determination, calculation, and control. The input device 130 receives key input and audio input from a user. The output device 140 is a display or the like that displays processing data. The hardware units 110 to 150 are connected to and able to communicate with each other via a bus.

The central processing unit 110 reads the program 115 stored in the storage device 120 into the memory 150 and executes the program 115, thereby implementing a function of a modification know-how learning section 111 for learning the modification know-how and a function of a plan generator 112 for generating a plan having the modification know-how reflected therein. In the storage device 120, data necessary to execute the functions is stored. Specifically, the data necessary to execute the functions is a constraint/objection function (plan requirement) 121, plan-related information 122, a plan result 123 before modification, a plan result 124 after the modification, a modification log 125, a modification rate table 126, an anti-pattern 127, a reference pattern 128, and modification know-how 129. Details of the data are described later. The program 115 is stored in the storage device 120, but may be introduced by the plan generating device 10 into the storage device 120 from another device via a predetermined medium when necessary, for example, at the time of the execution of the program 115. The medium is a storage medium attachable to and detachable from a predetermined interface of the plan generating device 10 or is a communication medium, for example.

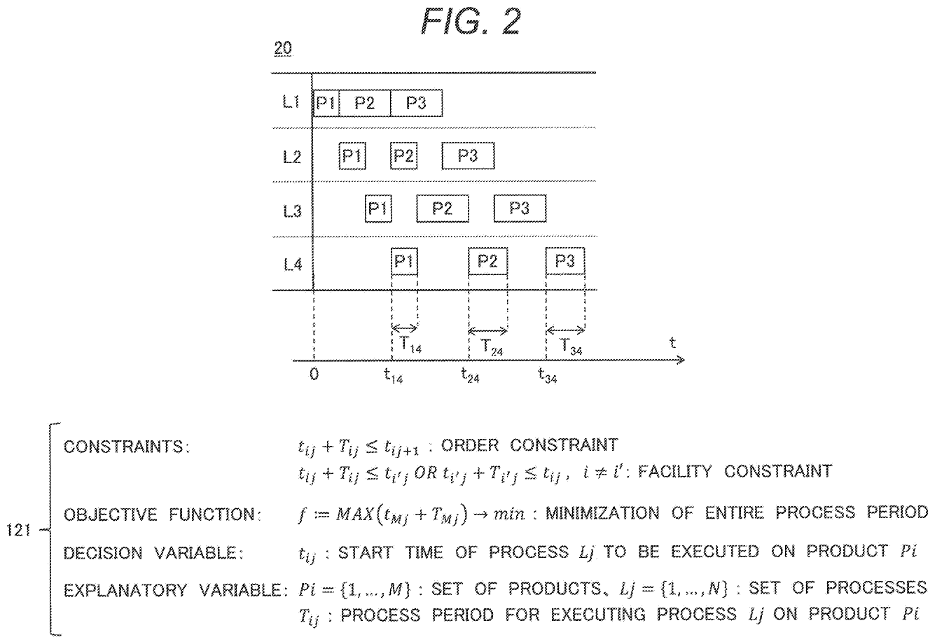

FIG. 2 illustrates an example of the plan generated by the plan generating device 10. This example assumes that the plan generating device 10 generates a production plan to execute a number N of processes Lj (j=1 to N) and produce a number M of products Pi (i=1 to M). For example, the production plan indicated in a Gantt chart 20 is generated. The Gantt chart 20 indicates an example in which N=4 and M=3. The Gantt chart 20 includes a time axis for a process L4.

FIG. 2 illustrates a plan requirement for the generation by the plan generating device 10 of the plan as indicated in the Gantt chart 20. To generate the production plan, a set Pi of products and a set Li of processes necessary to produce the products are defined and a process period Tᵢⱼ for executing each of the processes on each of the products is given (explanatory variables).

In the example illustrated in FIG. 2, as constraints, two constraints are provided. The first constraint is an order constraint. The order constraint indicates that, until each of the processes is completely executed on a current product, the process cannot start to be executed on another product. The second constraint is a facility constraint. The facility constraint indicates that a job cannot be executed on a plurality of products in each of the processes. As a target of the plan, an objective function f of minimizing a time period (entire process period) for completely executing all the processes on all the products is set. Therefore, in this case, generating the production plan means that the foregoing two constraints are satisfied and that start times tᵢⱼ (decision variables) of the processes to be executed on the products are calculated so as to minimize the objective function f. The foregoing description is an example. Other constraints such as a requirement for a combination of different types of products and a deadline requirement, or an objective function of minimizing a production cost or the like may be set. In addition, a plurality of objective functions may be set.

Data of the foregoing constraints, the objective function, the decision variables, and the explanatory variables is stored as the constraint/objective function (plan requirement) 121 of the storage device 120. Next, a data structure of data to be used by the plan generating device 10 to generate the plan is described.

The plan-related information 122 is collected for a past plan and is a set of data related to the plan. Details of the plan-related information 122 can be arbitrarily selected by a user as information that affects whether the plan is excellent or not. For example, it is desirable to determine data to be accumulated as the plan-related information 122 based on knowledge of which information is used to determine whether the modification is required or not, when the planner modifies the plan. As a specific example of the plan-related information 122, plan information 122a and product information 122b are used in this example.

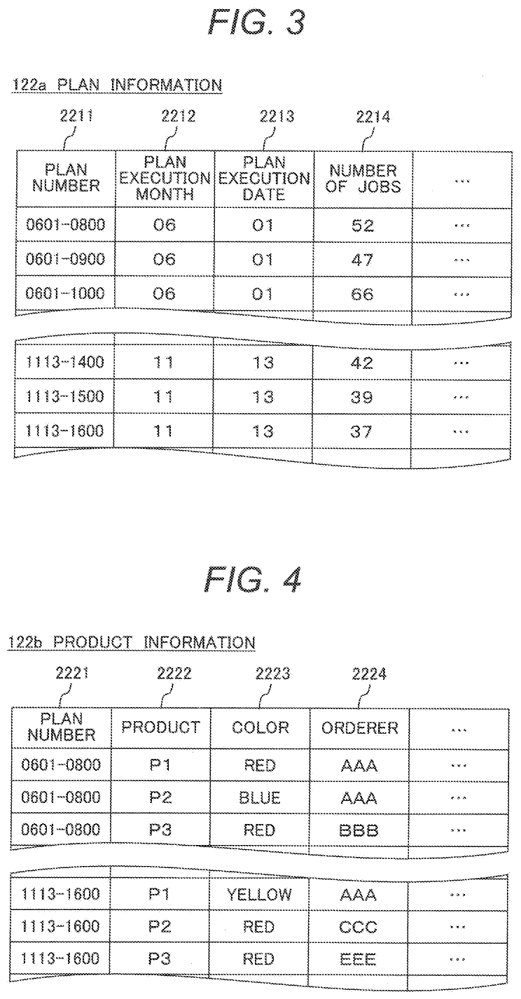

In each of records of the plan information 122a exemplified in FIG. 3, values of a plan number 2211, a plan execution month 2212, a plan execution date 2213, the number of jobs 2214, and the like are stored. The plan number 2211 is identification information uniquely identifying a plan. Records of the same plan number indicate information describing a plan of the plan number. The plan execution month 2212 indicates a month in which the plan is executed. The plan execution date 2213 indicates a date on which the plan is executed. The number of jobs 2214 indicates the total number (a number N of processes X a number M of products) of jobs for the plan. The foregoing data is collected as the plan information 122a describing the plan if the month in which the plan is executed or the date on which the plan is executed or an entire load for the plan are considered to affect whether the plan is excellent or not. The plan information 122a may include identification information uniquely identifying a planner, data of an operating state of a production facility, weather, and the like. As long as the user does not regard even the data exemplified in FIG. 3 as information describing the plan, the plan information 122a does not need to include such data. The same applies to other data described below.

In each of records of the product information 122b exemplified in FIG. 4, values of a plan number 2221, a product 2222, a color 2223, an orderer 2224, and the like are stored. The plan number 2221 is identification information uniquely identifying information of the plan and is the same as the plan number 2211. The product 2222 is identification information uniquely identifying a product for which the plan is provided. The color 2223 is a color of the product. The orderer 2224 is a code identifying an orderer who has ordered the product. The data collected as the product information 122b is selected as product information that affects whether the plan is excellent or not. This example assumes that the color information is included in the product information 122b, a painting process is included in the plan, and the color of the product affects painting order. Data of the type of the product, a deadline, and the like may be included in the product information 122b.

Next, the plan result 123 before the modification and the plan result 124 after the modification are described. The planner may modify a start time determined by the plan generating device 10 based on knowledge and know-how of the planner when necessary and carry out a modified plan. In this case, the plan before the modification and the plan after the modification are stored as the plan result 123 before the modification and the plan result 124 after the modification. Therefore, the plan (after the modification) stored in the corresponding plan result 124 after the modification exists corresponding to the plan (before the modification) stored in the plan result 123 before the modification.

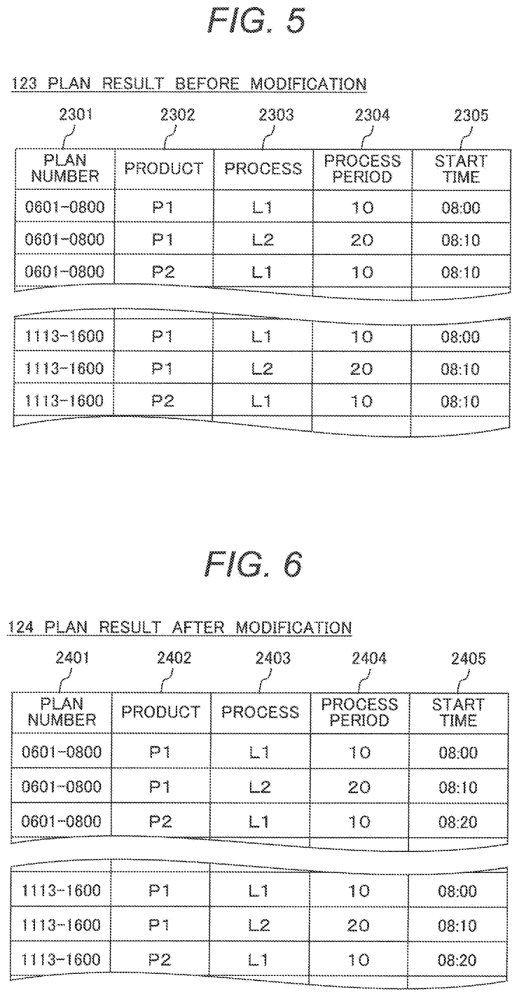

In each of records of the plan result 123 (exemplified in FIG. 5) before the modification, values of a plan number 2301, a product 2302, a process 2303, a process period 2304, a start time 2305, and the like are stored. The plan number 2301 is identification information uniquely identifying the plan and is the same as the plan number 2211. The product 2302 is identification information uniquely identifying a product for which the plan is provided. The process 2303 is identification information uniquely identifying a process to be executed according to the plan. The process period 2304 is a process period Tᵢⱼ for executing the process on the product. The start time 2305 is a start time tᵢⱼ of the process to be executed on the product. It can be understood that the Gantt chart illustrated in FIG. 2 can be generated from information of records of the same plan number. Values in fields for the product 2302, the process 2303, and the process period 2304 are given to generate the plan. A value in the field for the start time 2305 is determined by the plan generating device 10.

In each of records of the plan result 124 (exemplified in FIG. 6) after the modification, values of a plan number 2401, a product 2402, a process 2403, a process period 2404, a start time 2405, and the like are stored. Meanings of the items of the records of the plan result 124 after the modification are the same as meanings of the items of the plan result 123 before the modification illustrated in FIG. 5. For example, comparing the plan result 123 before the modification with the plan result 124 after the modification clarifies that a start time t₂₁ of a process L1 to be executed on a product P2 is modified from 08:10 to 08:20 in a plan of a plan number 0601-0800.

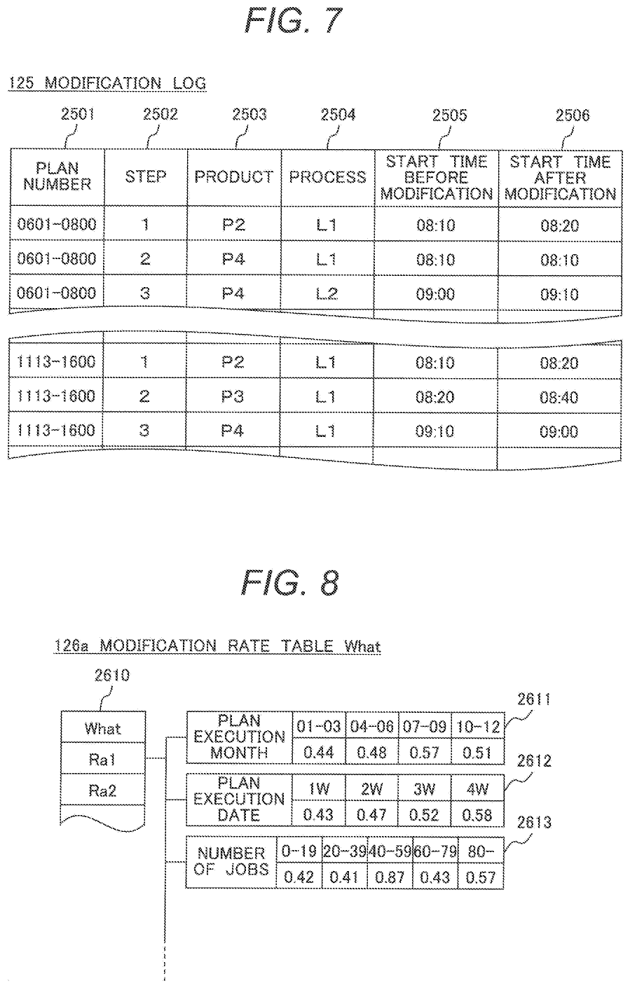

The modification log 125 is a modification log in which a modification action by the planner is recorded for each step. In each of records of the modification log 125 exemplified in FIG. 7, values of a plan number 2501, a step 2502, a product 2503, a process 2504, a start time 2505 before modification, a start time 2506 after the modification, and the like are stored. The plan number 2501 is identification information uniquely identifying the plan and is the same as the plan number 2211. The step 2502 indicates the order that the modification action by the planner is performed according to the plan of the plan number. For each plan number, modification actions are started in order from 1. The product 2503 is identification information uniquely identifying a product targeted for the modification. The process 2504 is identification information uniquely identifying a process targeted for the modification. The start time 2505 before the modification is a start time tᵢⱼ before the modification by the planner. Specifically, the start time 2505 before the modification is the start time determined by the plan generating device 10 in the plan generation. The start time 2506 after the modification is a start time tᵢⱼ modified by the planner. Since it is considered that the planner carries out the modification in order from an important modification, for example, a modification that largely affects another decision variable, the modification log 125 is stored as information indicating importance of individual modification details.

The foregoing data is primary data serving as basic data to be used by the plan generating device 10 to learn modification know-how of the planner. The modification rate table 126 is generated to identify, from the primary data, the condition that the planner frequently carries out a modification or hardly carious out a modification. As described later, the modification know-how is classified into groups, each of which has the same modification trend. In other words, groups of the modification know-how correspond to populations of the plan result 123 before the modification and the plan result 124 after the modification. The same modification trend is found from each of the populations. The modification rate table 126 indicates the primary data and statistical amounts of the decision variables of the plan before the modification for each of the groups. The types and the number of modification rate tables 126 held in the plan generating device 10 depend on details of the held primary data and the abundance of analysis viewpoints of the modification know-how. An example in which modification rate tables for four types of modification rates exist is described below.

FIG. 8 is a diagram illustrating a data structure of a modification rate table What 126a. The modification rate table What 126a is data indicating the condition that a plan is frequently modified or hardly modified for each of the items included in the plan information 122a.

The modification rate table What 126a exemplified in FIG. 8 has a plurality of records Rak (k=1 to O) 2610. Differences between the records Rak correspond to differences between the populations (groups) of the plan results 123 and 124 that are before and after the modification and are used to calculate modification rates What. Data structures of the records Rak are the same. FIG. 8 illustrates a data structure of a record Ra1 as a representative example. Sub-tables for the items of the plan information 122a are linked to the records Rak. Each of fields of a plan execution month sub-table 2611 indicates a modification rate for a respective one of plan execution months in a predetermined range. Each of the modification rates is the ratio of the number of plans modified by the planner to the number of plans generated by the plan generating device 10. However, a plan's parameter that is used to calculate a modification rate is the number of plans included in a population of a record Rak. In this example, the plan execution months are classified into groups of three months, and a modification rate is calculated for each of the groups of three months. For example, it is found that a plan modification rate in plan execution months from April to June is 48%. Each of fields of a plan execution date sub-table 2612 indicates a modification rate on a respective one of plan execution dates in a predetermined range. In this example, the plan execution dates are classified into groups of one week and a modification rate is calculated for each of the groups of one week. It is found that a plan modification rate in the second week is 47%. Each of fields of a number-of-jobs sub-table 2613 indicates a modification rate for a respective one of numbers of jobs in a predetermined range. In this example, the jobs are classified into groups of 20 jobs and a modification rate is calculated for each of the groups of 20 jobs. It is found that, when the number of jobs is in a range of 40 to 59, a modification rate is 87% and the jobs are modified with the highest probability.

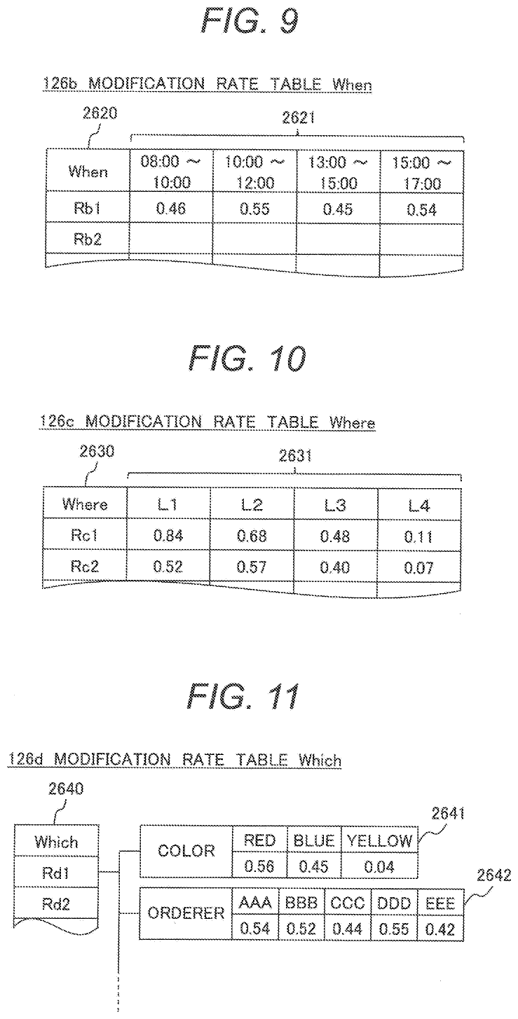

FIG. 9 is a diagram illustrating a data structure of a modification rate table When 126b. The modification rate table When 126b is data indicating the condition that a plan is frequently modified or hardly modified each of start times tᵢⱼ included in the plan result 123 before the modification.

In each of records of the modification rate table When 126b exemplified in FIG. 9, value of When 2620 and values of modification rates 2621 in time zones are stored. When 2620 is identification information uniquely identifying a population from which a modification rate When is calculated. When 2620 corresponds to the plurality of records Rak (k=1 to O) 2610 of the modification rate table What 126a exemplified in FIG. 8. Specifically, both a record Rak illustrated in FIG. 8 and a record Rbk illustrated in FIG. 9 comprise modification rates calculated from the same population. The values of the modification rates 2621 in the time zones indicate modification rates of jobs whose start times are in the time zones. This example indicates that the start times are classified into time periods of two hours and that a modification rate of a job to be started in a time zone from 10:00 to 12:00 is 55%.

FIG. 10 is a diagram illustrating a data structure of a modification rate table Where 126c. The modification rate table Where 126c is data indicating the condition that a plan is frequently modified or hardly modified for each of processes included in the plan result 123 before the modification.

In each of records of the modification rate table Where 126c exemplified in FIG. 10, value of Where 2630 and values of modification rates 2631 of processes are stored. Where 2630 indicates identification information uniquely identifying a population from which a modification rate Where is calculated. Where 2630 corresponds to the plurality of records Rak (k=1 to O) 2610 of the modification rate table What 126a exemplified in FIG. 8. Specifically, both a record Rak illustrated in FIG. 8 and a record Rck illustrated in FIG. 10 comprise modification rates calculated from the same population. The values of the modification rates 2631 of the processes indicate modification rates of plans including the processes. In this example, it is found that a modification rate of a process L1 is 84%, the process L1 is modified with the highest probability, a modification rate of a process L4 is 11%, and the process L4 is modified with the lowest probability.

FIG. 11 is a diagram illustrating a data structure of a modification rate table Which 126d. The modification rate table Which 126d is data indicating the condition that a plan is frequently modified or hardly modified for each of the items included in the product information 122b.

The modification rate table Which 126d exemplified in FIG. 11 includes a plurality of records Rdk (k=1 to 0) 2640. Which 2640 indicates identification information uniquely identifying a population from which a modification rate Which is calculated. Which 2640 corresponds to the plurality of records Rak (k=1 to O) 2610 of the modification rate table What 126a exemplified in FIG. 8. Specifically, both a record Rak illustrated in FIG. 8 and a record Rdk illustrated in FIG. 11 comprise modification rates calculated from the same population. Sub-tables for the items of the product information 122b are linked to the records Rdk. Each of fields of a color sub-table 2641 indicates a modification rate for a respective one of colors. For example, it is found that a modification rate for a job indicated by yellow is 4% and that the job is modified with the lowest probability. Each of fields of an orderer sub-table 2642 indicates a modification rate for a respective one of orderers. For example, the orderer sub-table 2642 indicates that a modification rate of a plan for a product ordered by an orderer BBB is 52%.

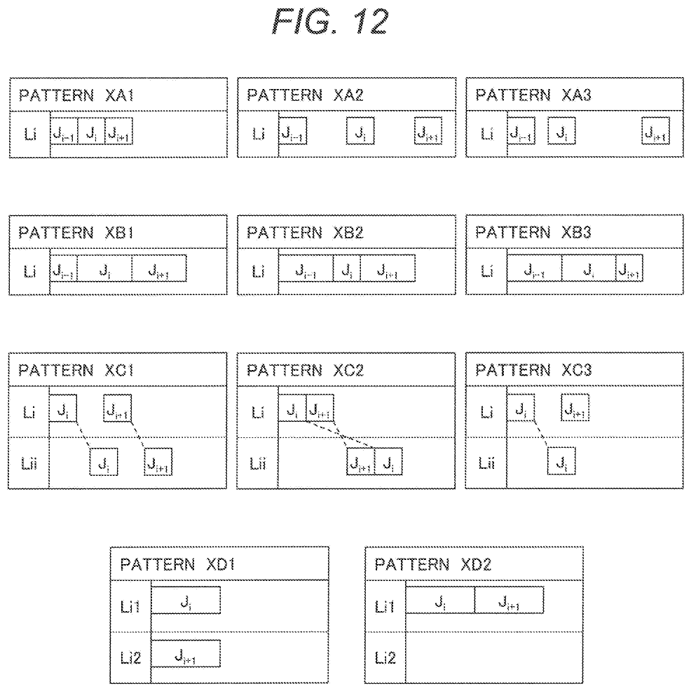

The plan generating device 10 recognizes a detail of a modification of a plan as a change in a pattern of such a Gantt chart as illustrated in FIG. 2. Therefore, in the plan generating device 10, a typical job pattern that appears in each of processes is defined as a unit job pattern in advance. FIG. 12 describes an example of definitions of unit job patterns for the processes. An abscissa for each of the patterns indicates time, and J indicates jobs to be executed in a time zone in each of the processes.

A pattern XA1, a pattern XA2, and a pattern XA3 are unit job patterns related to intervals between start times of jobs J of a certain process Li. The pattern XA1 is a pattern in which the jobs are left-aligned. The pattern XA2 is a pattern in which the jobs are aligned at equal intervals. The pattern XA3 is a pattern in which the jobs are randomly aligned. A pattern XB1, a pattern XB2, and a pattern XB3 are unit job patterns related to the order of jobs J of a certain process Li. The pattern XB1 is a pattern in which the jobs are aligned in order from a job to be executed for the shortest time period to a job to be executed for the longest time period. The pattern XB2 is a pattern in which the jobs are randomly aligned in terms of time periods for executing the jobs. The pattern XB3 is a pattern in which the jobs are aligned in order from the job to be executed for the longest time period to the job to be executed for the shortest time period. A pattern XC1, a pattern XC2, and a pattern XC3 are unit task patterns related to the order of jobs J when a certain process Li transitions to a process Lii. The pattern XC1 is a pattern in which the order of the jobs J before the transition is the same as the order of the jobs after the transition. The pattern XC2 is a pattern in which the order of the jobs before the transition is opposite to the order of the jobs after the transition. The pattern XC3 is a unit job pattern in which a job is not executed. A pattern XD1 and a pattern XD2 are unit job patterns related to a process Li1 and a process Li2 that are able to be executed at the same time. The pattern XD1 is a pattern in which jobs are executed in parallel. The pattern XD2 is a unit job pattern in which the jobs are executed in one of the processes. The foregoing patterns are examples. Various unit job patterns can be defined.

By defining patterns that appear in a Gantt chart, modification by the planner can be treated as conversion from a pattern before the modification to a pattern after the modification. In this case, a unit job pattern that is the pattern before the modification in many cases is considered to be avoided in the plan generation, and a unit job pattern that is the pattern after the modification in many cases is considered to be desirable for the plan generation. An anti-pattern 127 indicates trends of job patterns considered to be avoided in the plan generation. A reference pattern 128 indicates trends of patterns considered to be desirable for the plan generation.

FIG. 13 is a diagram illustrating a data structure of the anti-pattern 127. In each of records of the anti-pattern 127, value of Before 2700 and values of occurrence rates 2701 of patterns are stored. Before 2700 indicates identification information uniquely identifying a population (group) from which an occurrence rate Before is calculated. Before 2700 corresponds to the plurality of records Rak (k=1 to O) of the modification rate table What 126a exemplified in FIG. 8. Specifically, records Pak illustrated in FIG. 13 indicate occurrence rates Before calculated from the same populations as the records Rak illustrated in FIG. 8. The occurrence rates 2701 of the patterns are the occurrence rates Before of the patterns. Each of the occurrence rates Before is the ratio of the number of plans in which a pattern is to be modified to the number of plans generated by the plan generating device 10. However, the number of plans that is used to calculate the occurrence rate Before is the number of plans included in a population of the record Pak. In this example, an occurrence rate Before of the pattern XA1 is 93% in a record Pa1, and the pattern XA1 is considered to be a unit job pattern to be avoided in the plan generation.

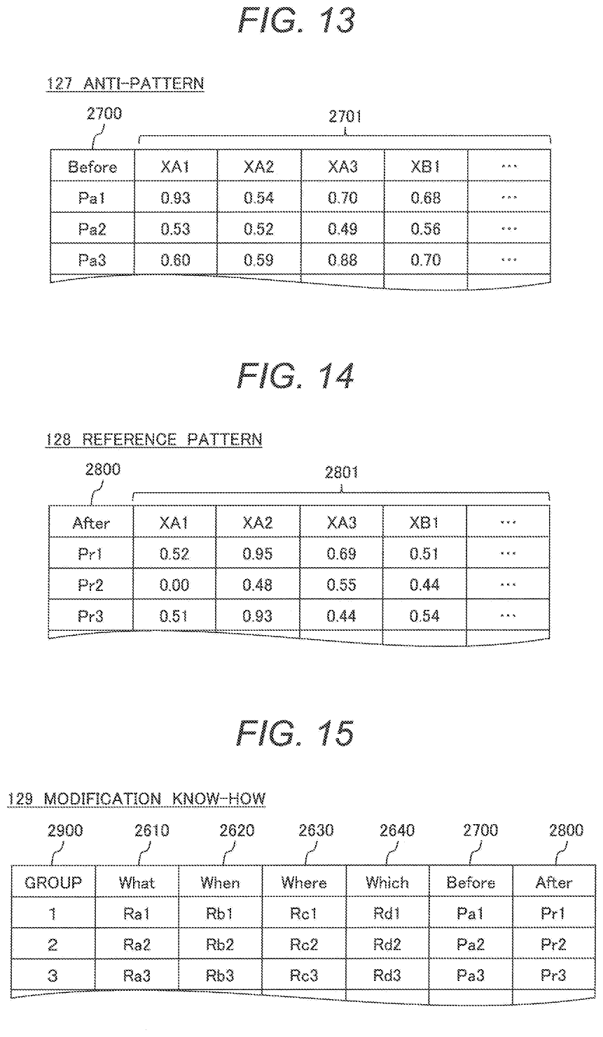

FIG. 14 is a diagram illustrating a data structure of the reference pattern 128. In each of records of the reference pattern 128, value of After 2800 and values of occurrence rates 2801 of patterns are stored. After 2800 indicates identification information uniquely identifying a population (group) from which an occurrence rate After is calculated. After 2800 corresponds to the plurality of records Rak (k=1 to O) of the modification rate table What 126a exemplified in FIG. 8. Specifically, records Prk illustrated in FIG. 14 indicate occurrence rates After calculated from the same populations as the records Rak illustrated in FIG. 8. An occurrence rate 2801 of a certain pattern is an occurrence rate After of the pattern, the occurrence rate After is the ratio of the number of plans in which a pattern has been changed to the certain pattern as a result of modification to the number of plans generated by the plan generating device 10. However, the number of plans that is used to calculate the occurrence rate After is the number of plans included in a population of the record Prk. In this example, an occurrence rate After of the pattern XA2 is 95% in a record Pr1, and the pattern XA2 is considered to be desirable for the plan generation.

The modification know-how 129 indicates correspondence between the modification rate tables 126, the anti-pattern 127, and the reference pattern 128. In this example, records of the data are corresponded based on the identity of populations from which the data is obtained. FIG. 15 is a diagram illustrating a data structure of the modification know-how 129. In each of the records of the modification know-how 129, values of a group 2900, What 2610, When 2620, Where 2630, Which 2640, Before 2700, and After 2800 are stored. Each of the values of the group 2900 is identification information uniquely identifying a set of records calculated from the same population.

Next, functions that are achieved by the plan generating device 10 using the foregoing data are described. As described above, the functions of the plan generating device 10 are implemented by the execution of the program 115.

The first function is a function of learning the modification know-how by the modification know-how learning section 111. The modification know-how learning section 111 analyzes the plan-related information 122, the plan result 123 that is before the modification and has been generated by the plan generating device 10, the plan result 124 that is after the modification and has been modified by the planner, and the modification log 125 of the modification. The modification know-how learning section 111 generates the data of the modification rate tables 126, the anti-pattern 127, the reference pattern 128, and the modification know-how 129.

The second function is a function of receiving, by the plan generator 112, new plan-related information for generation of a new plan via the input device 130, generating, by the plan generator 112, the new plan in which the modification know-how learned by the modification know-how learning section 111 has been reflected, and outputting the new plan by the plan generator 112 to the output device 140.

Process operations that are executed to achieve the functions are described below. The process operations are achieved by the program 115. The program 115 is composed of codes for executing various operations described below.

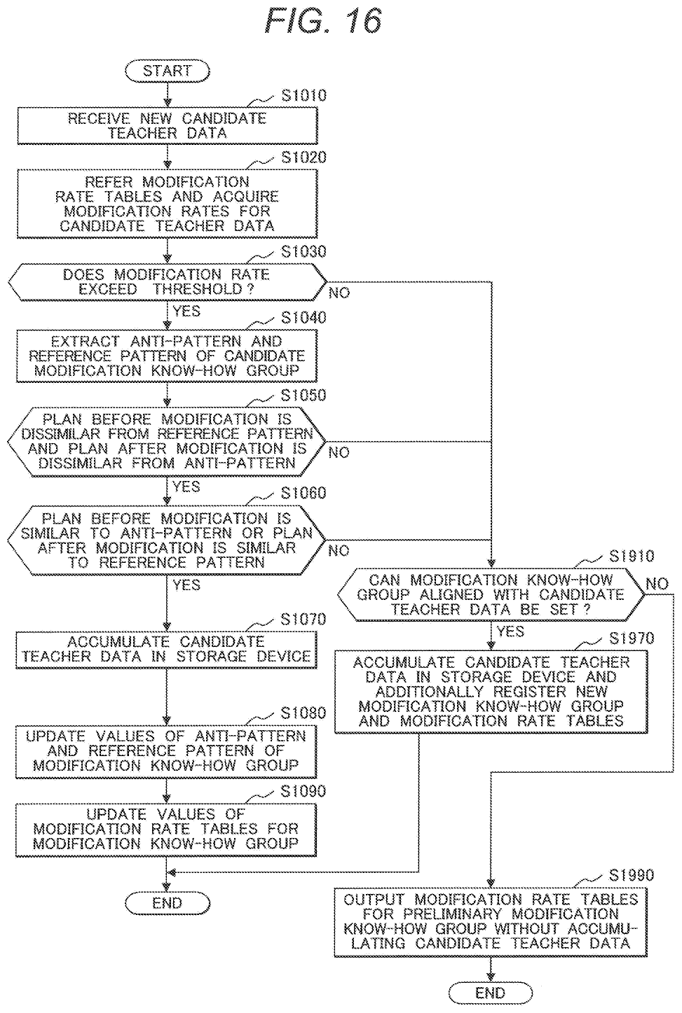

First, a process of achieving the first function is described. FIG. 16 is a diagram illustrating the flow of a process of generating and updating the modification know-how 129 by the modification know-how learning section 111. The modification know-how learning section 111 formalizes modification know-how of the planner from the plan-related information 122, the plan result 123 before the modification and the plan result 124 after the modification accumulated in the storage device 120 and stores the formalized modification know-how in the storage device 120. The flow of FIG. 16 indicates the process of updating the modification know-how by the plan generating device 10 when the modification know-how learning section 111 is activated in response to the reception of candidate teacher data by the input device 130. The candidate teacher data includes plan-related information, a plan before modification, and a plan after the modification that are necessary to update the modification know-how.

As a premise, the plan generating device 10 is aimed to output a plan that is similar to such a plan that is considered to satisfy the planner as a plan modified by the planner or a plan not modified by the planner, and is not similar to such a plan that is considered not to satisfy the planner as a plan before modification by the planner. Therefore, the plan generating device 10 firstly determines whether the candidate teacher data received is aligned with an existing population of modification know-how. When the candidate teacher data received is aligned with the existing population of the modification know-how, the plan generating device 10 adds the candidate teacher data to the population with which the candidate teacher data has been determined to be aligned as teacher data, and updates learning. In an initial state in which teacher data does not exist, 0.5 indicating an information amount of zero is stored as all values of the modification rate tables, the anti-pattern, and the reference pattern.

First, the modification know-how learning section 111 receives new candidate teacher data (S1010). The candidate teacher data is a data set including a plan before modification, a plan after the modification, corresponding plan-related information, and a corresponding modification log. When the candidate teacher data indicates a plan number “1113-1600”, the reception of the candidate teacher data corresponds to the reception of values of a record of the plan number “1113-1600” of the plan information 122a (refer to FIG. 3) as the plan-related information, values of a record of the plan number “1113-1600” of the product information 122b (refer to FIG. 4) as the plan-related information, values of a record of the plan number “1113-1600” of the plan result 123 before the modification (refer to FIG. 5) as the plan before the modification, values of a record of the plan number “1113-1600” of the plan result 124 after the modification (refer to FIG. 6) as the plan after the modification, and values of a record of the plan number “1113-1600” of the modification log 125 (refer to FIG. 7) as the modification log.

Subsequently, the modification know-how learning section 111 refers the modification rate tables 126 and acquires values of modification rates for the candidate teacher data (S1020). When the candidate teacher data indicates a plan of the plan number “1113-1600”, the modification know-how learning section 111 refers the record Ra1 (refer to FIG. 8) of the modification rate table What 126a and acquires a modification rate of 51% in a plan execution month (November), a modification rate of 47% on a plan execution date (13th=the second week), and a modification rate of 41% for the number (37) of jobs. Similarly, the modification know-how learning section 111 refers a record Rb1 (refer to FIG. 9) of the modification rate table When 126b and acquires a modification rate of 46% at a start time (8:30). The modification know-how learning section 111 refers a record Rc1 (refer to FIG. 10) of the modification rate table Where 126c and acquires a modification rate of 84% of a modified process (L1). The modification know-how learning section 111 refers a record Rd1 (refer to FIG. 11) of the modification rate table Which 126d and acquires a modification rate of 56% of a color (red) of a product and a modification rate of 44% of an orderer (CCC) of the product. The example in which the modification rates are acquired from the records included in the modification rate tables and associated with a group 1 (hereinafter referred to as “modification know-how 1”) defined in the modification know-how 129 is described above. However, when a plurality of groups are defined in the modification know-how 129, the modification know-how learning section 111 acquires modification rates from records associated with all the groups.

Subsequently, the modification know-how learning section 111 determines whether or not the received candidate teacher data is aligned with any of groups registered as modification know-how. When one or more of the values of the modification rates acquired in step S1020 exceeds a predetermined threshold (YES in S1030), the process proceeds to step S1040. When all the values of the modification rates acquired in step S1020 do not exceed the predetermined threshold (NO in S1030), the process proceeds to step S1910. If a modification rate is close to 100% or close to 0%, the foregoing requirement established means that a plan is significantly modified or is not significantly modified. In addition, if the modification rate is close to 50%, whether the plan is to be modified or not cannot be predicted from the establishment of the foregoing requirement. Therefore, in the process of step S1030, thresholds are set to a value close to 100% and a value close to 0%. For example, when the predetermined threshold is set to 80%, the modification rate of 84% that is indicated for the modified process and is associated with the plan number “1113-1600” in the record Rc1 of the modification rate table Where 126c exceeds the predetermined threshold. Therefore, since there is a possibility that the plan of the plan number “1113-1600” is indicated in teacher data aligned with the “modification know-how 1”, the process proceeds to step S1040.

In step S1040, the modification know-how learning section 111 refers the modification know-how 129 and extracts an anti-pattern and a reference pattern of a modification know-how group (hereinafter referred to as “candidate modification know-how group”) with which the candidate teacher data may be aligned in step S1030. For example, according to the modification know-how 129 (refer to FIG. 15), an anti-pattern of the “modification know-how 1” is the record Pa1 of the anti-pattern 127 (refer to FIG. 13), and a reference pattern of the “modification know-how 1” is the record Pr1 of the reference pattern 128 (refer to FIG. 14).

Subsequently, the modification know-how learning section 111 compares the anti-pattern extracted in step S1040 and the reference pattern extracted in step S1040 with the plans that are before and after the modification and are indicated in the candidate teacher data. In step S1050, the modification know-how learning section 111 determines that the candidate teacher data does not include a pattern having a trend opposite to the candidate modification know-how group. In other words, when the plan before the modification includes many patterns considered to be desirable for the plan generation according to the plan of the candidate modification know-how group, and the plan after the modification includes many patterns considered to be avoided in the plan generation according to the plan of the candidate modification know-how group, there is a possibility that the plan may have been modified due to an unknown cause and that a feature of the plan of the candidate modification know-how group may be reduced by adding the candidate teacher data to the candidate modification know-how group, and thus the candidate teacher data should not be added to the candidate modification know-how group. When the candidate teacher data does not include the pattern having the opposite trend, the process proceeds to step S1060. When the candidate teacher data includes the pattern having the opposite trend, the process proceeds to step S1910. However, when sufficient information is collected as the plan-related information 122, the candidate teacher data is not considered to include the pattern having the opposite trend, except for a special case.

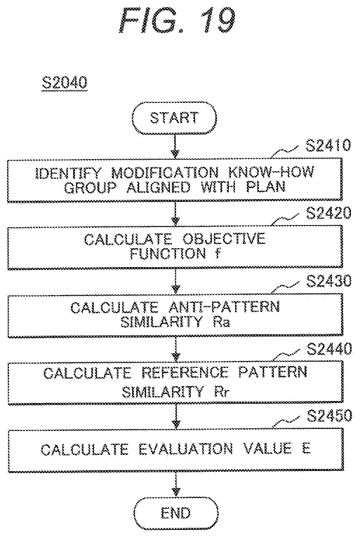

In step S1060, the modification know-how learning section 111 compares the plans that are before and after the modification and are indicated in the candidate teacher data with the anti-pattern and the reference pattern that are included in the candidate modification know-how group. When the plan before the modification is similar to the anti-pattern or the plan after the modification is similar to the reference pattern, the process proceeds to step S1070. When the plan before the modification is not similar to the anti-pattern and the plan after the modification is not similar to the reference pattern, the process proceeds to step S1910. To make the similarity determination in steps S1050 and S1060, the modification know-how learning section 111 may use an anti-pattern similarity Ra described later and a reference pattern similarity Rr (refer to FIG. 19) described later to calculate the anti-pattern similarity Ra of the plan before the modification and the reference pattern similarity Rr of the plan after the modification. When the similarities are equal to or larger than a predetermined threshold, the modification know-how learning section 111 determines that the plan before the modification is similar to the anti-pattern and that the plan after the modification is similar to the reference pattern.

In step S1070, the modification know-how learning section 111 causes the plan before the modification, the plan after the modification, the corresponding plan-related information, and the corresponding modification log of the candidate teacher data to be added to and accumulated in the plan result 123 before the modification, the plan result 124 after the modification, the plan-related information 122, and the modification log 125 in the storage device 120. Teacher data to be used in subsequent steps of step S1080 is the candidate teacher data used in steps S1010 to S1070.

In step S1080, the modification know-how learning section 111 causes the teacher data to be included in a population for the modification know-how group with which the teacher data has been determined to be aligned, and updates values of a corresponding record of the anti-pattern 127 (refer to FIG. 13) and values of a corresponding record of the reference pattern 128 (refer to FIG. 14).

In step S1090, the modification know-how learning section 111 causes the teacher data to be included in the population for the modification know-how group with which the teacher data has been determined to be aligned, and updates values of corresponding records of the modification rate tables 126 (refer to FIGS. 8 to 11). When the modification log 125 illustrated in FIG. 7 is already stored, the modification know-how learning section 111 may correct values of the modification rate tables to slightly large values for a record in which a value of step 2502 of the modification log 125 is smaller to a predetermined value. As the planner carries out a modification at an earlier stage, the modification is considered to be more important. Therefore, when a value that is included in a modification rate table and corresponds to an earlier modification is set to a relatively large value, there is an effect of largely reflecting the modification in the plan generation.

On the other hand, when the process proceeds to step S1910, the modification know-how learning section 111 can determine that the candidate teacher data is not aligned with any of existing modification know-how groups registered in the modification know-how 129. In step S1910, the possibility of a new modification know-how group with which the candidate teacher data is aligned is considered. For example, the modification know-how learning section 111 compares the plan that is before the modification and is indicated in the candidate teacher data with the plan result 123 that is before the modification and is stored in the storage device 120. The modification know-how learning section 111 compares the plan that is after the modification and is indicated in the candidate teacher data with the plan result 124 that is after the modification and is stored in the storage device 120. When the plan before the modification is similar to a plan indicated in the plan result 123 before the modification, the modification know-how learning section 111 extracts the similar plan before the modification from the plan result 123 before the modification. When the plan after the modification is similar to a plan indicated in the plan result 124 after the modification, the modification know-how learning section 111 extracts the similar plan after the modification from the plan result 124 after the modification. The modification know-how learning section 111 treats plans that are extracted as the similar plans both before and after the modification as a population of a preliminary modification know-how group and calculates the modification rate tables. When a significant value exists in an item included in the calculated modification rate tables, the modification know-how learning section 111 sets the preliminary modification know-how group as a new modification know-how group (S1970). When the significant value does not exist, the process proceeds to step S1990.

The modification know-how learning section 111 can treat plans to be compared as such Gantt charts as illustrated in FIG. 2 and determine a similarity between the plans based on a similarity between images of the Gantt charts. In addition, the modification know-how learning section 111 can determine, based on the threshold to be used to determine significance in step S1030, whether or not each of values of the obtained modification rate tables is a significant value.

In step S1970, the modification know-how learning section 111 causes the plan before the modification, the plan after the modification, the corresponding plan-related information, and the corresponding modification log of the candidate teacher data to be added to and accumulated in the plan result 123 before the modification, the plan result 124 after the modification, the plan-related information 122, and the modification log 125 in the storage device 120, newly additionally registers the modification rate tables calculated in step S1910, and registers a new modification know-how group in the modification know-how 129.

The foregoing process procedure is executed by the modification know-how learning section 111 to accumulate the candidate teacher data as teacher data and update the modification know-how. On the other hand, when the modification know-how group aligned with the candidate teacher data cannot be set in step S1910, the modification know-how learning section 111 does not accumulate the candidate teacher data as the teacher data. In this case, it is desirable that the modification know-how learning section 111 outputs the candidate teacher data and the modification rate tables calculated for the preliminary modification know-how group extracted in step S1910 (S1990). Therefore, the planner can individually analyze the candidate teacher data.

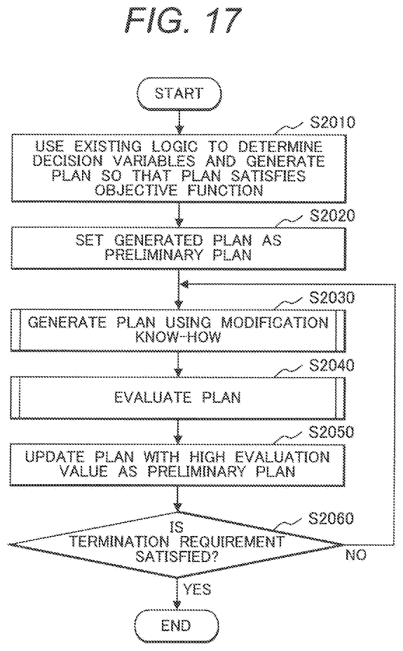

Next, a process procedure for generating a new plan using modification know-how in accordance with new plan-related information is described. FIG. 17 is a diagram illustrating the flow of a process of generating new plan information similar to plan information modified by the planner, executed by the plan generator 112, based on the modification know-how acquired by the modification know-how learning section 111. The flow of FIG. 17 indicates the process of generating a plan by the plan generating device 10 when the plan generator 112 is activated in response to the reception of plan-related information by the input device 130. In this case, the plan-related information is used to generate a new plan.

First, the plan generator 112 receives new plan-related information and uses existing logic to generate the plan (S2010). The existing logic is a general method of solving an optimization problem from the constraint/objective function 121 (refer to FIG. 2) stored in advance and is, for example, a local search algorithm, a genetic algorithm, or the like. When the plan newly generated has the plan number “1113-1600”, the values of the record of the plan number “1113-1600” of the plan information 122a (refer to FIG. 3) and the values of the record of the plan number “1113-1600” of the product information 122b (refer to FIG. 4) are received as the plan-related information that is input to the plan generator 112. The plan generated in step S2010 is held as a preliminary plan (S2020).

Next, the plan generator 112 treats the preliminary plan as an initial solution and generates the plan using the modification know-how (S2030). Details of step S2030 are described later. Subsequently, the plan generator 112 evaluates the generated plan (S2040). Details of step S2040 are described later.

In step S2050, the plan generator 112 compares an evaluation value calculated in step S2040 with an evaluation value of the preliminary plan. When the evaluation value calculated in step S2040 is equal to or larger than the evaluation value of the preliminary plan, the plan generator 112 updates the plan generated in step S2030 as the preliminary plan. When the evaluation value calculated in step S2040 is smaller than the evaluation value of the preliminary plan, the plan generator 112 maintains the preliminary plan.

In step S2060, the plan generator 112 checks whether the preliminary plan satisfies a termination requirement. When the preliminary plan does not satisfy the termination requirement, the plan generator 112 repeatedly executes the processes of steps S2030 to S2050. When the preliminary plan satisfies the termination requirement, the plan generator 112 outputs the preliminary plan as an optimal plan via the output device 140 and terminates the process illustrated in FIG. 17. The termination requirement may be a target value for the evaluation value of the preliminary plan or may be the number of times that the processes of steps S2030 to S2050 are repeatedly executed. Alternatively, the termination requirement may be a time elapsed after the start of the process executed by the plan generator 112. The termination requirement may be a combination of the target value, the elapsed time, and the number of times that the processes of steps S2030 to S2050 are repeatedly executed.

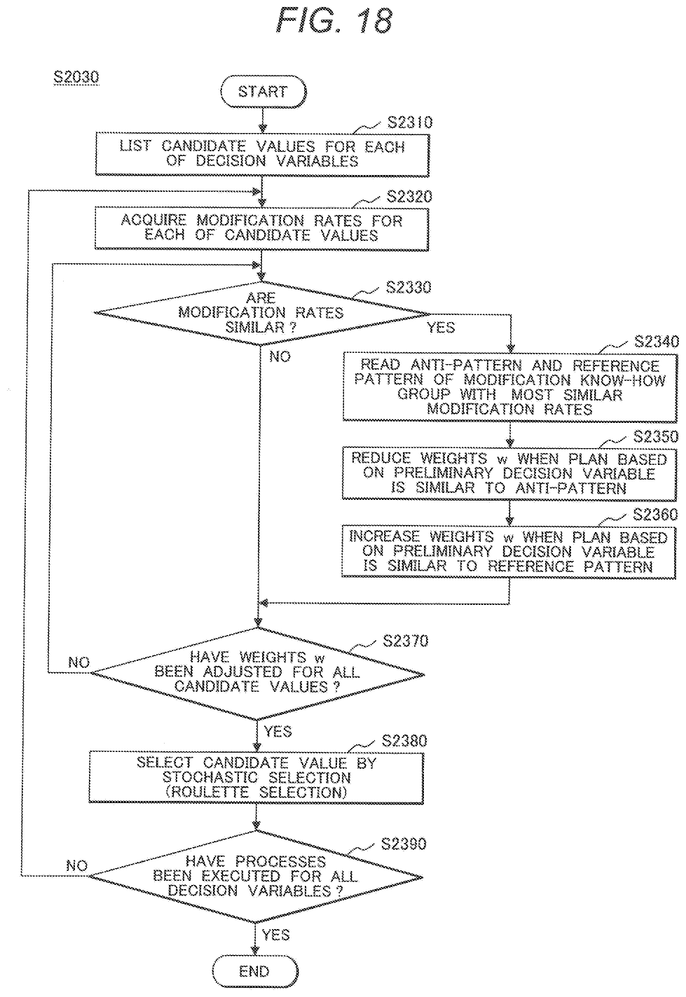

FIG. 18 is a flow diagram illustrating the process of step S2030 illustrated in FIG. 17.

The plan generator 112 lists a predetermined number of candidate values for each of decision variables (S2310). Specifically, the plan generator 112 selects one of the decision variables determined for the preliminary plan and calculates a predetermined number of candidate values in accordance with a predetermined algorithm. As the predetermined algorithm, a local search algorithm or the like may be used. The predetermined algorithm, however, is not limited. In this case, a weight w is set for each of the candidate values. At this stage, the weights w for the candidate values are equal to each other. For example, when 10 candidate values exist, each of the weights w for the candidate values is 0.1.

Next, the plan generator 112 acquires values of modification rates for each of the candidate values (S2320). Specifically, the plan generator 112 acquires the modification rates (hereinafter referred to as “preliminary decision variable”) while maintaining a value of a decision variable not to be subjected to the process of step S2310 as a value of the preliminary plan and treating a value of a decision variable to be subjected to the process of step S2310 as the candidate value. Therefore, when 10 candidate values exist, 10 sets of modification rates are acquired.

Subsequently, in step S2330, the plan generator 112 selects one set of modification rates, compares the modification rates acquired in step S2320 with modification rates of modification know-how groups (refer to FIG. 15), and determines whether or not the modification rates acquired in step S2320 are similar to the modification rates of the modification know-how groups. When differences between the values of the modification rates acquired in step S2320 and values of records of modification know-how groups of the modification rate tables (refer to FIGS. 8 to 11) are equal to or larger than a predetermined value, the plan generator 112 determines that the modification rates acquired in step S2320 are not similar to the modification rates of the modification know-how groups. When the differences are smaller than the predetermined value, the plan generator 112 determines that the modification rates acquired in step S2320 are similar to the modification rates of the modification know-how groups. When a plurality of modification know-how groups whose modification rates are smaller than the predetermined value exist, the plan generator 112 selects, from the plurality of modification know-how groups, a modification know-how group having modification rates whose differences from the modification rates acquired in step S2320 are the smallest, and executes the following process.

The plan generator 112 refers the modification know-how 129 (refer to FIG. 15) and reads an anti-pattern and a reference pattern of the modification know-how group decided in step S2330, that has modification rates that are similar to the acquired modification rates (S2340). Subsequently, the plan generator 112 compares a plan based on the preliminary decision variable with the read anti-pattern and the read reference pattern. When the plan based on the preliminary decision variable is similar to the anti-pattern, the plan generator 112 reduces the weights w for the candidate values (S2350). When the plan based on the preliminary decision variable is similar to the reference pattern, the plan generator 112 increases the weights w for the candidate values (S2360).

On the other hand, when a modification know-how group whose modification rates are similar to the acquired modification rates does not exist in step S2330, the plan generator 112 maintains the weights w. The plan generator 112 repeatedly executes the foregoing processes of steps S2330 and later on all the candidate values (S2370).

When the plan generator 112 completely adjusts the weights w for all the candidate values, the plan generator 112 selects a candidate value by stochastic selection (roulette selection) (S2380). In this case, by reducing the weights w for the candidate value whose selection in step S2380 leads to a plan including many anti-patterns or by increasing the weights w for the candidate value whose selection in step S2380 leads to a plan including many reference patterns, the probability that the candidate value that leads to a plan including many reference patterns is selected in step S2380 is increased.

The plan generator 112 executes the foregoing processes on all the decision variables (S2390) and determines values for all the decision variables. Then, the plan generator 112 terminates the plan generation (of step S2030) executed using the modification know-how.

FIG. 19 is a flow diagram illustrating the process of step S2040 illustrated in FIG. 17. An example in which an evaluation value is calculated according to the following Equation (1) is described below.

An evaluation value E=the objective function f+α×1/the anti-pattern similarity Ra+β×the reference pattern similarity Rr (Equation 1)

In Equation (1), α and β are positive constants.

The plan generator 112 firstly identifies a modification know-how group aligned with the plan (S2410). In this case, the plan generator 112 identifies the modification know-how group by extracting the modification know-how group whose modification rates are similar to the acquired modification rates in the same manner as step S2330 illustrated in FIG. 18. The plan generator 112 identifies the modification know-how group whose modification rates are the most similar to the acquired modification rates, when a plurality of modification know-how groups whose modification rates are similar to the acquired modification rates exist. When the modification know-how group whose modification rates are similar to the acquired modification rates does not exist, the plan generator 112 sets (1/the anti-pattern similarity Ra) and the reference pattern similarity Rr to zero.

Next, the plan generator 112 calculates the objective function f (S2420). The objective function f is given in advance (refer to FIG. 2).

Next, the plan generator 112 calculates the anti-pattern similarity Ra of the identified modification know-how group (S2430). The anti-pattern similarity Ra can be defined as the sum of values obtained by multiplying similarities between an image of a Gantt chart of the plan to be evaluated and images of Gantt charts of the patterns illustrated in FIG. 12 by values of a record corresponding to the modification know-how group of the anti-pattern 127.

Next, the plan generator 112 calculates the reference pattern similarity Rr of the identified modification know-how group (S2440). The reference pattern similarity Rr can be defined as the sum of values obtained by multiplying the similarities between the image of the Gantt chart of the plan to be evaluated and the images of the Gantt charts of the patterns illustrated in FIG. 12 by values of a record corresponding to the modification know-how group of the reference pattern 128.

In step S2450, the plan generator 112 uses the value of the objective function f calculated in step S2420, the value of the anti-pattern similarity Ra calculated in step S2430, and the value of the reference pattern similarity Rr calculated in step S2440 to calculate the evaluation value E according to Equation (1). The evaluation value E is larger as the objective function f and the reference pattern similarity Rr are larger and the anti-pattern similarity Ra is smaller. The plan is more highly evaluated as the objective function f is larger, the number of patterns desirable for the plan generation is larger, and the number of patterns to be avoided in the plan generation is smaller.

According to the embodiment described above, it is possible to formalize modification know-how of the planner from the plan result before the modification and the plan result after the modification, reflect the modification know-how in the plan generation, and output the plan satisfying the planner.

Although the embodiment of the present invention is described above in detail, the present invention is not limited to the embodiment and can be variously modified without departing from the gist of the present invention. Although the plan generating device 10 includes the modification know-how learning section 111 and the plan generator 112, a computer may include the modification know-how learning section 111 and another computer may include the plan generator 112, for example. In this case, the computer that includes the plan generator 112 may generate a plan using modification know-how of the computer including the modification know-how learning section 111.

### REFERENCE SIGNS LIST

10: Plan generating device, 20: Gantt chart, 110: Central processing unit, 111: Modification know-how learning section, 112: Plan generator, 115: Program, 120: Storage device, 121: Constraint/objective function, 122: Plan-related information, 122a: Plan information, 122b: Product information, 123: Plan result before modification, 124: Plan result after modification, 125: Modification log, 126: Modification rate table, 126a: Modification rate table What, 126b: Modification rate table When, 126c: Modification rate table Where, 126d: Modification rate table Which, 127: Anti-pattern, 128: Reference pattern, 129: Modification know-how, 130: Input device, 140: Output device, 150: Memory

What is claimed is:

1. A plan generating device comprising:
a storage device that stores plan requirement data indicating a constraint and an objective function that are used to generate a plan, and modification know-how data indicating modification know-how for the plan;
an input device that receives new plan-related information data indicating predetermined plan-related information including an explanatory variable of the constraint and the objective function for the new plan; and
a plan generator that uses the new plan-related information data received from the input device, the plan requirement data read from the storage device, and the modification know-how data read from the storage device to determine a decision variable for the constraint and the objective function,
wherein the modification know-how data includes a plurality of groups for which an anti-pattern indicating trends of job patterns of a plurality of plans before modification, a reference pattern indicating trends of job patterns of a plurality of plans after modification that have been obtained by modifying the plans before the modification by a planner, and a modification rate that is a statistical amount of the plan-related information and the decision variable of the plurality of plans before the modification, have been obtained, and
the plan generator determines the decision variable for the new plan so that the new plan satisfies the constraint and the objective function and is aligned with any of the groups included in the modification know-how data.

2. The plan generating device according to claim 1,
wherein the plan generator sets a plurality of candidate values for the decision variable determined as a preliminary plan for the new plan, and
when a first modification rate that is a statistical amount of the plan-related information indicated in the new plan-related information data and the decision variable being set as the candidate values is similar to a modification rate of any of the groups included in the modification know-how data, the plan generator adjusts weights for the candidate values based on similarities between the anti-pattern and the reference pattern of the group whose modification rate is similar to the first modification rate and a job pattern of the preliminary plan for which the decision variable is set as the candidate value, and
the plan generator selects, as a value of the decision variable, any of the candidate values for which the weights have been adjusted.

3. The plan generating device according to claim 2,
wherein the plan generator uses evaluation values to compare the preliminary plan with a second preliminary plan obtained by selecting the decision variable of the preliminary plan as any of the candidate values, and updates, as a new preliminary plan, a preliminary plan that is either the preliminary plan or the second preliminary plan and has a higher evaluation value, and
the evaluation values are defined based on a value of the objective function of the plan to be evaluated and similarities between a job pattern of the plan to be evaluated and the anti-pattern and the reference pattern of the group included in the modification know-how data whose modification rate is similar to the modification rate that is a statistical amount of the plan-related information and the decision variable of the plan to be evaluated.

4. The plan generating device according to claim 1,
wherein a plurality of typical job patterns that appear in the job patterns of the plans are defined as unit job patterns,
the anti-pattern is defined as appearance frequencies of the unit job patterns in the job patterns of the plans before the modification for the groups included in the modification know-how data, and
the reference pattern is defined as appearance frequencies of the unit job patterns in the job patterns of the plans after the modification for the groups included in the modification know-how data.

5. The plan generating device according to claim 1, further comprising a modification know-how learning section that updates the modification know-how data,
wherein the input device receives candidate teacher data,
the candidate teacher data includes a plan before modification for learning, a plan after the modification for learning that has been obtained by modifying the plan before the modification for the learning by a planner, and the plan-related information of the plan before the modification for the learning, and
the modification know-how learning section uses the candidate teacher data to update the modification know-how data when the modification know-how learning section determines that the candidate teacher data is aligned with any of the groups included in the modification know-how data or that a group with which the candidate teacher data is aligned can be set.

6. The plan generating device according to claim 5,
wherein when the plan-related information and the decision variable of the plan before the modification for the learning have a common feature to a modification rate of a certain group among the groups included in the modification know-how data, the modification know-how learning section adds the candidate teacher data to the certain group and updates the modification rate of the certain group, the anti-pattern, and the reference pattern.

7. The plan generating device according to claim 6,
wherein the groups included in the modification know-how data include a first group, and
when a statistical amount of a modification rate of the first group for either the plan-related information or the decision variable of the plan before the modification for the learning exceeds a predetermined threshold, the modification know-how learning section determines that the candidate teacher data is aligned with the first group.

8. The plan generating device according to claim 6,
wherein the candidate teacher data includes a modification log indicating the order of modifications by the planner in the plan after the modification for the learning, and
the modification know-how learning section refers the modification log and corrects a value of a modification rate related to a modification carried out at a predetermined early stage to increase the value of the modification rate, when the modification know-how learning section adds the candidate teacher data to a certain group among the groups included in the modification know-how data and update a modification rate, the anti-pattern, and the reference pattern of the certain group.

9. The plan generating device according to claim 5, further comprising:
an arithmetic unit; and
a memory,
wherein the storage device stores a program, and
the arithmetic unit implements a function of the plan generator or a function of the modification know-how learning section by reading the program from the storage device into the memory and executing the program.

10. A plan generation method using a plan generating device including a storage device that stores plan requirement data indicating a constraint and an objective function that are used to generate a plan and modification know-how data indicating know-how for the plan, an input device that receives plan-related information data indicating predetermined plan-related information including an explanatory variable of the constraint and the objective function for the plan, and a plan generator that determines a decision variable for the constraint and the objective function,
wherein the modification know-how data includes a plurality of groups for which an anti-pattern indicating trends of job patterns of a plurality of plans before modification, a reference pattern indicating trends of job patterns of a plurality of plans after modification that have been obtained by modifying the plans before the modification by a planner, and a modification rate that is a statistical amount of the plan-related information and the decision variable of the plurality of plans before the modification, have been obtained, and
the plan generation method comprises the steps of:
causing the input device to receive new plan-related information data indicating the plan-related information of the new plan; and
causing the plan generator to use the new plan-related information data received from the input device, the plan requirement data read from the storage device, and the modification know-how data read from the storage device to determine the decision variable for the new plan so that the new plan satisfies the constraint and the objective function and is aligned with any of the groups included in the modification know-how data.

11. The plan generation method according to claim 10,
wherein the plan generating device includes a modification know-how learning section that updates the modification know-how data,
causing the input device to receive candidate teacher data including a plan before modification for learning, a plan after modification for learning that has been obtained by modifying the plan before the modification for the learning by a planner, and the plan-related information of the plan before the modification for the learning, and
causing the modification know-how learning section to update the modification know-how data by using the candidate teacher data, when the modification know-how learning section determines that the candidate teacher data is aligned with any of the groups included in the modification know-how data or that a group with which the candidate teacher data is aligned can be set.
